(19) United States
(12) Patent Application Publication
(10) Pub. No.: US 2022/0306917 A1
(43) Pub. Date: Sep. 29, 2022

(54) METHOD FOR SEPARATING ADHESIVES

(71) Applicant: Evonik Operations GmbH, Essen (DE)

(72) Inventors: Nicolai Kolb, Recklinghausen (DE); Peter Altenbuchner, Münster (DE); Gabriele Brenner, Dülmen (DE); Bernhard Schleimer, Marl (DE)

(73) Assignee: Evonik Operations GmbH, Essen (DE)

(21) Appl. No.: 17/611,160

(22) PCT Filed: May 7, 2020
(86) PCT No.: PCT/EP2020/062739

§ 371 Date: Nov. 14, 2021

(30) Foreign Application Priority Data
May 17, 2019 (EP) 19175091.8

(51) Int. Cl. C09J 175/06; B08B 7/00; C08G 18/28; C08G 18/42; C08G 18/76; C08G 18/48

(52) U.S. Cl. CPC C09J 175/06; B08B 7/0021; C08G 18/289; C08G 18/42; C08G 18/7671; C08G 18/4825; B08B 2220/01; C08G 2170/20; C09J 2301/502

(57) ABSTRACT

The present invention relates to a method in which an adhesive bond is brought into contact with a supercritical fluid, characterized in that the adhesive bond is based on one or more adhesives comprising crosslinked polymers, where the crosslinked polymers have at least one oxygen atom in the polymer chain and have been crosslinked via urethane bridges or —O—CH₂—CH(OH)—CH₂—O— bridges or molecular chains having corresponding bridges, and in that after bringing the adhesive bond into contact with the supercritical fluid, at least one of the parameters pressure, volume, amount of substance or temperature is changed such that the fluid transitions from the supercritical state into a different state, and also to the use of this method as at least a substep in a method for separating adhesive bonds of components.

### CROSS REFERENCE TO RELATED APPLICATIONS

This application is a 35 U.S.C. § 371 U.S. national phase entry of International Application No. PCT/EP2020/062739 having an international filing date of May 7, 2020, which claims the benefit of European Application No. 19175091.8 filed May 17, 2019, each of which is incorporated herein by reference in its entirety.

### FIELD

The present invention relates to a method in which an adhesive bond is brought into contact with a supercritical fluid, characterized in that the adhesive bond is based on one or more adhesives comprising crosslinked polymers, where the crosslinked polymers have at least one oxygen atom in the polymer chain, and the crosslinked polymers have been crosslinked via urethane bridges or —O—CH₂—CH(OH)—CH₂—O— bridges or molecular chains having corresponding bridges, and in that after bringing the adhesive bond into contact with the supercritical fluid, at least one of the parameters pressure, volume, amount of substance or temperature is changed such that the fluid transitions from the supercritical state into a different state, and also to the use of this method as at least a substep in a method for separating adhesive bonds of components.

### BACKGROUND

Chemically reactive adhesives, for example polyurethane adhesives—both moisture-curing 1-component and also 2-component adhesives—are used in many industrial processes where particularly high demands are made on the adhesive bond. Especially in terms of thermal stability (heat resistance), polyurethane adhesives exhibit outstanding properties.

However, it is a current legal requirement that bonded products be recycled again at the end of the life cycle, or that they be separable for the purpose of repairs without causing serious damage to the components, for example in electronic devices such as mobile telephones or displays. For such recycling or separation, the adhesive had to be separable “on demand” (De-Bonding on Demand, abbreviated to DBD).

A customary approach for De-Bonding on Demand is the introduction of temperature, as a result of which the adhesion and/or the cohesion are influenced. There are various approaches in this regard, for example the addition of a non-reactively incorporated resin into the adhesive formulation, which resin “softens” the adhesive at temperatures above the softening point and correspondingly lowers the cohesion (WO2016/000222). However, this approach is disadvantageous since the non-reactively incorporated polymers usually lead to a lower cohesion of the adhesive even at lower temperatures.

Supercritical fluids, in particular supercritical CO₂, are well known in the literature and combine the properties of liquid and gas. More precisely, they are space-filling liquids having the viscosity of gases and good diffusion properties.

The use of supercritical CO₂ has been described for numerous applications. For example, the cleaning of metallic substrates which have been contaminated on the surface with paints or adhering substances by extraction by means of supercritical CO₂ is described (WO 2006095371 A1). A similar extraction/cleaning process has also been described for paper (EP 480476 A1).

In addition, it is known how thermoplastics, such as for example thermoplastic polyurethane (TPU), can be foamed by treatment with supercritical CO₂ (US 20170259473 A1).

This process for foaming has also been investigated for pressure-sensitive adhesives. Here, acrylic polymers were surface-modified by treatment with supercritical CO₂ in order to obtain improved adhesive strength (EP 1008637 A2).

It has further been shown that components that have been adhesively bonded by means of thermoplastic, non-reactive adhesive bonds can be debonded again using supercritical CO₂, in that the adhesive is dissolved by the supercritical CO₂ and washed out (WO 9826886 A1). However, compared to the abovementioned, highly crosslinked reactive adhesives, such thermoplastic adhesive bonds are mechanically less stable and correspondingly unfavorable with respect to cohesion and longevity, which markedly limits their industrial use.

### SUMMARY

The objective thus remained of developing a method which permits debonding of bonded parts without destruction, where the adhesive is not to exhibit any penalties in mechanical or adhesive performance prior to the debonding.

Surprisingly, it has been found that this object can be achieved if the adhesive or the adhesive bond is treated with a supercritical fluid. Within the context of the present invention, it has also surprisingly been found that even (highly) crosslinked reactive adhesives, in particular polyurethane adhesives, can be affected by the treatment with supercritical CO₂ in such a way that they lose their adhesive strength to the extent that destruction-free separation of the bonded parts is possible. Surprisingly, this even works in an adhesively bonded joint where the adhesive is only accessible to the supercritical fluid with great difficulty.

### DETAILED DESCRIPTION

The present invention accordingly provides a method in which an adhesive bond is brought into contact with a supercritical fluid, characterized in that the adhesive bond is based on one or more adhesives comprising crosslinked polymers, where the crosslinked polymers have at least one oxygen atom in the polymer chain and the crosslinked polymers have been crosslinked via urethane bridges or —O—CH₂—CH(OH)—CH₂—O— bridges or molecular chains having corresponding bridges, and in that after bringing the adhesive bond into contact with the supercritical fluid, at least one of the parameters pressure, volume, amount of substance or temperature is changed such that the fluid transitions from the supercritical state into a different state, as is claimed in the claims.

The present invention also provides for the use of this method according to the invention as at least a substep in a method for separating adhesive bonds of components.

The method according to the invention has the advantage that as a result of the transition of the supercritical fluid into the gaseous or liquid state, the adhesive bond or the adhesive is foamed so greatly that the adhesive strength decreases sufficiently to be able to separate the components—preferably without destruction—from one another.

By means of the method according to the invention, the tensile shear forces that have to be applied to separate an adhesive bond can preferably be reduced by at least 50%.

A further advantage of the method according to the invention consists in that customary adhesive compositions can be used, so that the industrial requirements with respect to mechanical load-bearing capacity and longevity of the adhesive bonds are not affected.

The method according to the invention and the use according to the invention are described below by way of example, without any intention that the invention be limited to these illustrative embodiments. Where ranges, general formulae or classes of compounds are specified below, these are intended to encompass not only the corresponding ranges or groups of compounds which are explicitly mentioned but also all subranges and subgroups of compounds which can be obtained by removing individual values (ranges) or compounds. Where documents are cited in the context of the present description, their content shall fully form part of the disclosure content of the present invention, particularly in respect of the matters referred to. Where figures are given in percent hereinafter, these are percentages by weight unless stated otherwise. Where averages, for example molar mass averages, are specified hereinafter, these are the numerical average unless stated otherwise. Where properties of a material are referred to hereinafter, for example viscosities or the like, these are properties of the material at 25° C. unless otherwise stated. Where chemical (empirical) formulae are used in the present invention, the reported indices may be either absolute numbers or average values. For polymeric compounds, the indices preferably represent average values.

The method according to the invention in which an adhesive bond is brought into contact with a supercritical fluid has the feature that the adhesive bond is based on one or more adhesives comprising crosslinked polymers, where the crosslinked polymers have at least one oxygen atom in the polymer chain, and the crosslinked polymers have been crosslinked via urethane bridges or —O—CH₂—CH(OH)—CH₂—O— bridges or molecular chains having corresponding bridges, and in that after bringing the adhesive bond into contact with the supercritical fluid, at least one of the parameters pressure, volume, amount of substance or temperature is changed such that the fluid transitions preferably from the supercritical state into a different state. The supercritical fluid preferably transitions preferably from the supercritical state into the gaseous state.

Within the context of the present invention, “adhesive bonds” are understood to mean those which adhesively bond at least two components with one another. The adhesive bonds may in this case be embodied in an areal or abutting fashion.

Adhesives comprising crosslinked polymers are understood within the context of the present invention to be those adhesives which react chemically after the physical application of the adhesive via a subsequent further chemical reaction, either with the environment (for example air humidity in the case of reactive adhesives) or with themselves (for example 2-component polyurethane or epoxy adhesive). For example, the adhesives can be moisture-curable or radiation-curable or thermally crosslinking adhesives, preferably polyurethane adhesives. Such crosslinked adhesives are typically no longer soluble or meltable after complete curing/reaction and have a markedly higher cohesion than non-reactive adhesives.

In the method according to the invention, the supercritical fluid is preferably supercritical carbon dioxide.

The crosslinked polymers are preferably based on polyester polyols and/or polyether polyols, preferably polyester polyols.

The polyether polyols can be any known polyether polyols; they are preferably polyethylene glycol, polypropylene glycol or copolymers of ethylene glycol and propylene glycol, random or blockwise distributions of the monomers both being possible.

The polyester polyols can be any known polyester polyols. Preferred adhesive bonds are based at least in part on amorphous polymers, preferably amorphous polyester polyols. Amorphous polymers are distinguished by the fact that no melting peak is detectable in DSC for these polymers. DSC stands for differential scanning calorimetry, which is conducted according to DSC method DIN 53765 using a heating rate of 10 K/min. According to this, amorphous polymers do not have a melting temperature, but rather only a glass transition temperature. Depending on the glass transition temperature, the amorphous polymers are either in a liquid or solid, glass-like form at room temperature.

It may be particularly advantageous if the crosslinked polymers are based on polyester polyols, in particular amorphous polyester polyols, having an OH number determined according to DIN 53240-2 of less than 30 mg KOH/g, preferably of 1 to 25 mg KOH/g, especially since these crosslinked polymers can be foamed more intensely.

The polyester polyols used are preferably those having a functionality of at least 1, by preference 1 to 100, preferably 1.5 to 20, and particularly preferably 2.0 to 10, which by preference contain at least one diol or polyol and at least one di- or polycarboxylic acid. With regard to the polyols and polycarboxylic acids, there are no restrictions in principle, and it is possible in principle for any mixing ratios to occur. The selection is guided by the desired physical properties of the polyester. At room temperature, these may be solid and amorphous, liquid and amorphous or/and (semi)crystalline.

Polycarboxylic acids are understood to mean compounds bearing more than one carboxyl group and preferably two or more carboxyl groups. In the context of the present invention, carboxyl functionalities are also understood to mean derivatives thereof, for example esters or anhydrides.

The polycarboxylic acids may preferably be aromatic or saturated or unsaturated aliphatic or saturated or unsaturated cycloaliphatic di- or polycarboxylic acids. Preference is given to using dicarboxylic acids. Examples of suitable aromatic di- or polycarboxylic acids and derivatives thereof are compounds such as dimethyl terephthalate, terephthalic acid, isophthalic acid, naphthalenedicarboxylic acid and phthalic anhydride. Examples of linear aliphatic di- or polycarboxylic acids include oxalic acid, dimethyl oxalate, malonic acid, dimethyl malonate, succinic acid, dimethyl succinate, glutaric acid, dimethyl glutarate, 3,3-dimethylglutaric acid, adipic acid, dimethyl adipate, pimelic acid, suberic acid, azelaic acid, dimethyl azelate, sebacic acid, dimethyl sebacate, undecanedicarboxylic acid, decane-1,10-dicarboxylic acid, dodecane-1,12-dicarboxylic acid, brassylic acid, tetradecane-1,14-dicarboxylic acid, hexadecane-1,16-dioic acid, octadecane-1,18-dioic acid, dimer fatty acids and mixtures thereof. Examples of unsaturated linear di- and/or polycarboxylic acids include itaconic acid, fumaric acid, maleic acid or maleic anhydride. Examples of saturated cycloaliphatic di- and/or polycarboxylic acids include derivatives of cyclohexane-1,4-dicarboxylic acids, cyclohexane-1,3-dicarboxylic acids and cyclohexane-1,2-dicarboxylic acids.

It is possible in principle to use any desired polyols for the preparation of the polyesters. Polyols are understood to mean compounds bearing more than one hydroxyl group and preferably two or more hydroxyl groups. For instance, linear or branched aliphatic and/or cycloaliphatic and/or aromatic polyols may be present.

Examples of suitable diols or polyols are ethylene glycol, propane-1,2-diol, propane-1,3-diol, butane-1,4-diol, butane-1,3-diol, butane-1,2-diol, butane-2,3-diol, pentane-1,5-diol, hexane-1,6-diol, octane-1,8-diol, nonane-1,9-diol, dodecane-1,12-diol, neopentyl glycol, butylethylpropane-1,3-diol, methylpropane-1,3-diol, methylpentanediols, cyclohexanedimethanols, tricyclo[2.2.1]decanedimethanol, isomers of limonenedimethanol, isosorbitol, trimethylolpropane, glycerol, hexane-1,2,6-triol, pentaerythritol, polyethylene glycol, polypropylene glycol and mixtures thereof.

Aromatic diols or polyols are understood to mean reaction products of aromatic polyhydroxyl compounds, for example hydroquinone, bisphenol A, bisphenol F, dihydroxynaphthalene etc., with epoxides, for example ethylene oxide or propylene oxide. Diols or polyols present may also be ether diols, i.e. oligomers or polymers based, for example, on ethylene glycol, propylene glycol or butane-1,4-diol.

Polyols or polycarboxylic acids having more than two functional groups may be used as well, such as trimellitic anhydride, trimethylolpropane, pentaerythritol or glycerol, for example. Moreover, lactones and hydroxycarboxylic acids may be used as constituents of the polyester. Preference is given to using bifunctional diols and dicarboxylic acids.

The preferred polyester polyols can preferably be synthesized via a melt condensation. For this purpose, the aforementioned di- or polycarboxylic acids and diols or polyols are initially charged and melted in an equivalent ratio of hydroxyl to carboxyl groups of 0.5 to 1.5, preferably 1.0 to 1.3. The polycondensation preferably takes place in the melt at temperatures between 150 and 280° C. over the course of 3 to 30 hours. In the course of this, a majority of the amount of water released is preferably initially distilled off at standard pressure. In the further course, the remaining water of reaction, and also volatile diols, are preferably eliminated, until the target molecular weight is achieved. This can optionally be facilitated by means of reduced pressure, by enlarging the surface area, or by passing an inert gas stream through the reaction mixture. The reaction can additionally be accelerated by addition of an azeotrope former and/or of a catalyst, before or during the reaction. Examples of suitable azeotrope formers are toluene and xylenes. Examples of suitable catalysts are organotitanium or organotin compounds such as tetrabutyl titanate or dibutyltin oxide. Also conceivable are catalysts based on other metals, such as zinc or antimony, for example, and also metal-free esterification catalysts. Also possible are further additives and process aids such as antioxidants or color stabilizers.

The adhesives may either consist of just one polyol or else of a plurality of different polyols; the adhesive is preferably formulated using a plurality of polyether polyols or/and polyester polyols.

Aside from the polymers, preferably polyester polyols, the adhesives may have further auxiliaries customary for adhesive formulations, for example non-OH-functionalized polymers, for example thermoplastic polyurethanes (TPUs) and/or polyacrylates and/or ethylene-vinyl acetate copolymers (EVA); pigments or fillers, for example talc, silicon dioxide, titanium dioxide, barium sulfate, calcium carbonate, carbon black or colored pigments; tackifiers, for example rosins, hydrocarbon resins, phenolic resins, and ageing stabilizers and auxiliaries. The proportion of auxiliaries in the adhesives may be up to 50% by weight, preferably from 0.1% to 25% by weight, based on the overall adhesive formulation.

The crosslinked polymers have preferably been crosslinked via urethane bridges/bonds or molecular chains having corresponding bridges and not via —O—CH₂—CH(OH)—CH₂—O— bridges or molecular chains having corresponding bridges. The crosslinked polymers are particularly preferably based on polyether polyols and/or polyester polyols, preferably at least partially on amorphous polyester polyols, and have been crosslinked via urethane bridges/bonds or molecular chains having corresponding bridges.

The crosslinking via bridges having the unit —O—CH₂—CH(OH)—CH₂—O— or molecular chains having corresponding bridges can be effected, for example, by using compounds containing glycidyl ether groups. Such compounds can be obtained, for example, via reaction of an OH group with epichlorohydrin.

The urethane bridges/bonds or molecular chains having corresponding bridges/bonds can be obtained, for example, by using isocyanate compounds. Suitable isocyanate compounds are preferably diphenylmethane 4,4′-diisocyanate, diphenylmethane 2,4′-diisocyanate, toluene diisocyanate isomers, isophorone diisocyanate, hexamethylene diisocyanate, dicyclohexylmethane 4,4′-diisocyanate or mixtures thereof, preferably diphenylmethane 4,4′-diisocyanate or a mixture of diphenylmethane 4,4′-diisocyanate and diphenylmethane 2,4′-diisocyanate.

During the process of bringing the adhesive bond into contact with the supercritical fluid according to the invention, the adhesive of the adhesive bond or the adhesive bond is preferably loaded with the supercritical fluid.

The adhesive bond is brought into contact with the supercritical fluid by preference for a period of from 1 minute to 48 hours, preferably 10 minutes to 24 hours and particularly preferably 2 to 22 hours. By means of a longer period of contacting with the supercritical fluid, the reduction in tensile shear forces can be increased.

In the method according to the invention, the change in one of the parameters pressure, volume, amount of substance or temperature, so that the fluid transitions from the supercritical state into a different state, is by preference effected within a period of less than 15 seconds, preferably of less than or equal to 10 seconds.

The method according to the invention can be used to reduce the tensile shear forces of the adhesive bond by preference by at least 50%, preferably at least 80%.

It may be advantageous if, when using the method according to the invention, the adhesive bond is completely detached from at least one of the adhesively bonded components. It may also be advantageous if the adhesive bond becomes so unstable that the components can be separated without the action of forces. In this case, the adhesive bond may completely detach from at least one of the adhesively bonded components or the adhesive bond itself may fall apart.

Accordingly, the method according to the invention is preferably used as at least a substep in a method for separating adhesive bonds of components.

The surfaces of the adhesively bonded components or the adhesively bonded components themselves can comprise or consist of the same materials. However, the surfaces of the adhesively bonded components or the adhesively bonded components themselves can also comprise or consist of dissimilar materials. The materials are preferably selected from metal, plastic or wood. Preferably, at least one adhesively bonded component or the surface thereof comprises or consists of a metal.

Even without further elaboration it is assumed that a person skilled in the art will be able to utilize the description above to the greatest possible extent. The subject-matter of the present invention is elucidated in more detail on the basis of the examples which follow, without any intention that the subject-matter of the present invention be restricted to these.

### EXAMPLES

### Measurement Methods:

### 1. Determination of the Thermal Properties

The thermal properties of the polymers used in the context of the present invention are determined by differential scanning calorimetry (DSC) in accordance with the DSC method DIN 53765. The values of the second heating interval are stated and the heating rate was 10 K/min.

### 2. Tensile Shear Strengths

The bonding properties of the adhesives/adhesive formulations used in the context of the present invention were determined on the basis of the tensile shear strength in accordance with DIN EN 1465 in N/mm².

### 3. OH Number

The polymers used often have hydroxyl groups as end groups. The concentration of the OH groups is determined in accordance with DIN 53240-2 by titrimetric means in mg KOH/g of polymer.

### 4. NCO Number

The NCO number was determined in accordance with DIN EN 1242 by titrimetric means in % by weight.

### 5. Gel Permeation Chromatography

The number-average and weight-average molecular weight (Mn and Mw, respectively) of the polymers used in the context of the present invention is determined according to DIN 55672-1 by means of gel permeation chromatography in tetrahydrofuran as eluent and polystyrene for calibration.

### Substances Used:

The substances given in table 1 were used:

TABLE 1
Raw materials used

| | |
|---|---|
| P1 | DYNACOLL ® 7150: hydroxy-terminated polyester (from Evonik |
| | Resource Efficiency GmbH) with OH number of 43, T_{g} = 50° C. |
| P2 | DYNACOLL ® 7250: hydroxy-terminated polyester (from Evonik |
| | Resource Efficiency GmbH) with OH number of 21, T_{g} = −50° C. |
| P3 | DYNACOLL ® 7360: hydroxy-terminated polyester (from Evonik |
| | Resource Efficiency GmbH) with OH number of 30, T_{g} = −60° C., |
| | Tₘ = 55 |
| P4 | DYNACOLL ® 7380: hydroxy-terminated polyester (from Evonik |
| | Resource Efficiency GmbH) with OH number of 30, T_{g} = 70° C. |
| P5 | DYNACOLL ® EP 413.10: hydroxy-terminated polyester (from |
| | Evonik Resource Efficiency GmbH) with OH number of 20, T_{g} = |
| | 30° C. |
| P6 | DYNACOLL ® EP 415.10: hydroxy-terminated polyester (from |
| | Evonik Resource Efficiency GmbH) with OH number of 20, T_{g} = |
| | 50° C. |
| P7 | PPG 2000: hydroxy-terminated polypropylene glycol (from DOW) |
| | with Mn = 2 kDa |
| P8 | DYNACOLL ® AC 1630: polyacrylate with T_{g} = 63° C., Mw = |
| | 60 kDa, OH number = 0 |
| OA1 | VESTOPLAST ® 206: silane-modified polyolefin (from Evonik |
| | Resource Efficiency GmbH) |
| EA1 | 2-component epoxy power glue (do-it-yourself) from Fischer; |
| | consisting inter alia of bisphenol A-epichlorohydrin resin with |
| | Mn of 700 g/mol |
| EA2 | 2-component epoxy adhesive (do-it-yourself) from Uhu; con- |
| | sisting of epoxy resin, polyamide resin, polyethylene polyamines |
| | and tetraethylene pentamine |

### Production of PU Hotmelt Formulations Used:

For the production of the PU hotmelt formulations used, in a 500 ml flange flask 300 g of the polyol mixtures given in table 2 were melted at 130° C. and dried under reduced pressure for 45 minutes. Subsequently, the amount of diphenylmethane 4,4′-diisocyanate (Desmodur® 44M—from Covestro) specified in Table 2 was added in a molar OH/NCO ratio of 1:2.2 and the mixture was rapidly homogenized. For complete conversion of the co-reactants, the mixture was stirred under a protective gas atmosphere at 130° C. for 45 minutes. Subsequently, the moisture-curing hotmelt adhesive was dispensed.

The curing of the adhesives for the production of films or adhesive joints was effected by means of 2 weeks of storage at 20° C. and 65% rel. atmospheric humidity.

TABLE 2
Composition of the PU hotmelt formulations used

| | | Initial weight of |
|---|---|---|
| Formulation | Composition of polyols (wt. %) | Desmodur ® 44M |
| PU1 | P1 (57.5% by weight)/P2 (28.8% | 13.7% by weight |
| | by weight) | |
| PU2 | P2 (90.5% by weight) | 9.5% by weight |
| PU3 | P5 (61.3% by weight)/P2 (30.6% | 8.1% by weight |
| | by weight) | |
| PU4 | P6 (61.5% by weight)/P2 (30.7% | 7.8% by weight |
| | by weight) | |
| PU5 | P3 (88.0% by weight) | 12.0% by weight |
| PU6 | P4 (87.6% by weight) | 12.4% by weight |
| PU7 | P3 (44.8% by weight)/P7 (24.5% | 12.0% by weight |
| | by weight)/P8 (18.7% by weight) | |

### Preparation of a Silane-Terminated Polymer STP1:

In a 500 ml flange flask, about 300 g of polyol P2 were dried at 130° C. under reduced pressure (<10 mbar) for 45 minutes. Thereafter, the melt was cooled down to 80° C., and 0.03 g of DBTL and 29 g of 3-isocyanatopropyltrimethoxysilane (VESTANAT® EP-IPMS—from Evonik Resource Efficiency GmbH) were added in a molar OH/NCO ratio of 1:1 and the mixture was homogenized at 80° C. under nitrogen for 45 minutes. Subsequently, 0.15 g of DBTL as curing catalyst was added and the mixture was immediately dispensed.

The curing of the adhesives for the production of films or adhesive joints was effected by means of 2 weeks of storage at 20° C. and 65% rel. atmospheric humidity.

### Preparation of Epoxy Adhesive Formulations EA1 & EA2

The 2-component epoxy adhesives were prepared according to the manufacturer's instructions for use.

Treatment of Adhesive Bonds with Supercritical Fluid

The adhesive bonds/test specimens to be investigated (adhesive films or adhesively bonded substrates) were treated (loaded) with 100 bar of CO₂ at a temperature of 50° C. in a 1 L steel reactor and the conditions were maintained for 20 hours. Subsequently, the reactor was depressurized to standard pressure within 10 seconds and the test specimens were removed for further analysis.

### Assessment of the Expansion of the Cured Adhesive Films:

To assess whether the adhesive films used could bring about a reduction in adhesive strength in the adhesive bond as a result of the described loading with supercritical CO₂ and subsequent depressurization, films of cured adhesives having dimensions of 3×3 cm were cut to size and expansion was assessed for each dimension. The layer thickness of the films prior to expansion was 1.2 mm.

The degree of expansion is assessed here in the following scales: 0 (expansion <10%)/+(expansion 10-50%)/++(expansion >50%). The results are shown in Table 3.

TABLE 3

| Formulation | Degree of expansion |
|---|---|
| PU1 | + |
| PU2 | ++ |
| PU3 | ++ |
| PU4 | ++ |
| PU5 | 0 |
| PU6 | 0 |
| PU7 | ++ |
| STP 1 | 0 |
| OA1 | 0 |
| EA1 | 0 |

Tests PU1 to PU7 show that polyurethane films based on polyester polyols can be expanded particularly well under the given conditions if high proportions of amorphous polyols are present in the adhesive. Adhesive systems based on pure crystalline polyols (PU5 and PU6) did not display any great expansions, however PU7 exhibited very good expansion with a high content of the crystalline polyol. In addition, adhesive bonds based on polyester polyols with a low OH number appear to exhibit better expansion properties.

Reactive adhesives which are not polyurethane adhesives did not have any significant effect in the investigations; this applies to the silane-functionalized polyolefin OA1, the silane-terminated polyol STP1 and the 2-component epoxy adhesives EA1 and EA2.

For the formulation PU3, the tensile shear strengths of adhesive bonds of different materials were determined before and after treatment via sCO₂. The results are shown in table 4.

TABLE 4

| Formu- | Substrate | Substrate | TSS before | TSS after | Drop in |
|---|---|---|---|---|---|
| lation | 1 | 2 | sCO2 | sCO2 | TSS in % |
| PU3 | Steel | Steel | 1.2/a | 0.1/a | >90% |
| PU3 | Steel | PET film | 0.7/a | 0.3/a | >50% |

a = adhesive fracture

It can clearly be gathered from table 4 that in particular in the case of metal adhesive bonds the adhesive strength in terms of the tensile shear strength was very significantly reduced.

1. A method in which an adhesive bond is brought into contact with a supercritical fluid, wherein the adhesive bond is based on one or more adhesives comprising crosslinked polymers, where the crosslinked polymers have at least one oxygen atom in the polymer chain, and the crosslinked polymers have been crosslinked via urethane bridges or —O—CH₂—CH(OH)—CH₂—O— bridges or molecular chains having corresponding bridges, and in that after bringing the adhesive bond into contact with the supercritical fluid, at least one of the parameters pressure, volume, amount of substance or temperature is changed such that the fluid transitions from the supercritical state into a different state.

2. The method according to claim 1, wherein the supercritical fluid is supercritical carbon dioxide.

3. The method according to claim 1, wherein the crosslinked polymers are based on polyether polyols and/or polyester polyols.

4. The method according to claim 1, wherein the crosslinked polymers have been crosslinked via urethane bridges or molecular chains having corresponding bridges and not via —O—CH₂—CH(OH)—CH₂—O— bridges or molecular chains having corresponding bridges.

5. The method according to claim 1, wherein the fluid transitions from the supercritical state into the gaseous state.

6. The method according to claim 1, wherein, during the process of bringing the adhesive bond into contact with the supercritical fluid, the adhesive of the adhesive bond is loaded with the supercritical fluid.

7. The method according to claim 1, wherein the adhesive bond is brought into contact with the supercritical fluid for a period of from 1 minute to 48 hours.

8. The method according to claim 1, wherein the change in one of the parameters pressure, volume, amount of substance or temperature, so that the fluid transitions from the supercritical state into a different state, is effected within a period of less than 15 seconds.

9. The method according to claim 1, wherein it is used to reduce the tensile shear forces of the adhesive bond.

10. The method according to claim 1, wherein the adhesive bond is completely detached from at least one of the adhesively bonded components.

11. The method according to claim 1, wherein it is used as at least a substep in a method for separating adhesive bonds of components.

12. The method according to claim 1, wherein the surfaces of the adhesively bonded components comprise or consist of the same materials.

13. The method according to claim 1, wherein the surfaces of the adhesively bonded components comprise or consist of dissimilar materials.

14. The method according to claim 1, wherein the materials are selected from metal, plastic or wood.

15. The method according to claim 1, wherein at least one adhesively bonded component or the surface thereof comprises or consists of a metal.

16. The method according to claim 1, wherein the adhesive bond is brought into contact with the supercritical fluid for a period of from 10 minutes to 24 hours.

17. The method according to claim 1, wherein the change in one of the parameters pressure, volume, amount of substance or temperature, so that the fluid transitions from the supercritical state into a different state, is effected within a period of less than 10 seconds.

18. The method according to claim 1, wherein it is used to reduce the tensile shear forces of the adhesive bond by at least 50%.

19. The method according to claim 2, wherein the crosslinked polymers are based on polyether polyols.

20. The method according to claim 2, wherein the crosslinked polymers have been crosslinked via urethane bridges or molecular chains having corresponding bridges and not via —O—CH₂—CH(OH)—CH₂—O— bridges or molecular chains having corresponding bridges.
